(19) United States
(12) Patent Application Publication
(10) Pub. No.: US 2004/0012585 A1
(43) Pub. Date: Jan. 22, 2004

(54) Simulation apparatus for simulating interacting movements of fluid and solid

(75) Inventor: Tsunemi Takahashi, Kanagawa (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/462,760

(22) Filed: Jun. 17, 2003

(30) Foreign Application Priority Data
Jun. 20, 2002 (JP) 2002-179420

(51) Int. Cl. G06T 15/00

(52) U.S. Cl. 345/419

(57) ABSTRACT

A simulation apparatus for simulating movements of a fluid and a solid both interacting with each other. The apparatus includes a mesh setting unit, a solid shape setting unit and a solid simulation unit. The mesh setting unit sets a uniform simulation mesh in an object region of a simulation. The solid shape setting unit sets a shape of the solid in the uniform simulation mesh. The solid simulation unit simulates the movement of the solid on the basis of the shape while taking into account an acting force on the solid exerted by the fluid.

The present disclosure relates to the subject matter contained in Japanese Patent Application No. 2002-179420 filed Jun. 20, 2002, which is incorporated herein by reference in its entirety.

### BACKGROUND OF THE INVENTION

1Field of the Invention

The present invention relates to a simulation apparatus for simulating movements of a fluid and a solid when interacting with each other, and a method and a program therefor, all of which are appropriate for three-dimensional computer graphics (CG).

2. Background Art

Simulating the interactive forces acting between a fluid and a solid is especially important for engineering. The ALE (Arbitrary Lagrangian Eulerian) method and the sliding mesh method are well known. The ALE method is used mainly to determine the effect produced on fluid by a vibrating object. The sliding mesh method is employed mainly to determine the effect produced on fluid by a rotating object.

According to these simulation calculation methods, a calculation is performed while a simulation area is divided into nonstructural meshes that correspond to the shape of a solid. While a detailed simulation suitable for engineering use can be performed by employing these simulation calculation methods, both methods impose a huge calculation load and are not appropriate for use of non-engineering fields poor in calculation resources.

For computer graphics field, Foster and Fedkiw respectively have proposed fluid simulation methods, which are combinations of the level set method and the particle method. According to these methods, calculations can be done allowing an effect produced by a moving object to be applied to a fluid. By these methods scenes can be created where the fluid is agitated. In these methods, however, only unidirectional calculation is performed with regard to the interaction between the solid and the fluid. That is, the effect produced by the movement of the solid can be applied for the fluid, whereas the effect produced by the movement of the fluid cannot be applied for the solid. Therefore, it is difficult to create a scene wherein a solid is rotated upon the application of the force exerted by the movement of a fluid, such as a strong stream of water. It is also difficult to employ the fluid simulation method for a situation where complicated changes occur in the movement of a fluid. Accordingly, a realistic scene cannot be easily created.

### SUMMARY OF THE INVENTION

The invention may provide a simulation apparatus for simulating movements of a fluid and a solid both interacting with each other. The apparatus includes: a mesh setting unit configured to set a uniform simulation mesh in an object region of a simulation; a solid shape setting unit configured to set a shape of the solid in the uniform simulation mesh; and a solid simulation unit configured to simulate the movement of the solid on the basis of the shape while taking into account an acting force on the solid exerted by the fluid.

Further, the invention may provide a simulation apparatus including: an object shape setting unit configured to set a shape of the solid object in a simulation mesh; a fluid external force calculating unit configured to calculate an acting force on the solid object exerted by the fluid; and an object simulation unit configured to simulate the movement of the solid object while taking into account the acting force on the solid object exerted by the fluid.

Further, the invention may provide a simulation apparatus, including: a converting unit configured to convert a shape data value of the solid into a volume-of-solid value; a mapping unit configured to map the VOS value on a simulation mesh; an external force calculating unit configured to employ pressure of the fluid at a time t to calculate a translational force and a torque acting on the solid at the time t; a solid simulation unit configured to calculate the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t; a velocity setting unit configured to set fluid velocity around the solid at the same value as the velocity of the solid at the time t+Δt; a first fluid simulation unit configured to calculate a fluid velocity and a volume-of-fluid value at the time t+Δt on the basis of a fluid velocity, the pressure, a volume-of-fluid value and a velocity of the fluid around the solid at the time t; and a second fluid simulation unit configured to calculate a pressure of the fluid at the time T+Δt on the basis of the velocity and the volume-of-fluid value of the fluid at the time t+Δt and the velocity of the fluid around the solid at the time t+Δt set by the velocity setting unit.

The invention may provide a simulation method for simulating movements of a fluid and a solid both interacting with each other. The method includes: setting a shape of the solid in a uniform simulation mesh; and simulating the movement of the solid on the basis of the shape while taking into account an acting force on the solid exerted by the fluid.

Further, the invention may provide a simulation method, including: converting a shape data value of the solid into a volume-of-solid value; mapping the volume-of-solid value on a simulation mesh; calculating a translational force and a torque acting on the solid at the time t by using pressure of the fluid at a time t ; calculating the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t; setting fluid velocity around the solid at the same value as the velocity of the solid at the time t+Δt; calculating a fluid velocity and a volume-of-fluid value at the time t+Δt on the basis of a fluid velocity, the pressure, a volume-of-fluid value and a velocity of the fluid around the solid at the time t; and calculating a pressure of the fluid at the time t+Δt on the basis of the velocity and the volume-of-fluid value of the fluid at the time t+Δt and the velocity of the fluid around the solid at the time t+Δt.

The invention may provide a simulation program for computationally simulating movements of a fluid and a solid that interact with each other, the simulation program causes a computer to function as: mesh setting means for setting a uniform simulation mesh in an object region of a simulation; solid shape setting means for setting a shape of the solid in the uniform simulation mesh; and solid simulation means for simulating the movement of the solid on the basis of the shape while taking into account an acting force on the solid exerted by the fluid.

The invention may provides a recording medium for recording a simulation program for computationally simulating movements of a fluid and a solid that interact with each other in a computer. The program causes the computer to function as: converting means for converting a shape data value of the solid into a volume-of-solid value; mapping means for mapping the VOS value on a simulation mesh; external force calculating means for employing pressure of the fluid at a time t to calculate a translational force and a torque acting on the solid at the time t; solid simulation means for calculating the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t; velocity setting means for setting fluid velocity around the solid at the same value as the velocity of the solid at the time t+Δt; first fluid simulation means for calculating a fluid velocity and a volume-of-fluid value at the time t+Δt on the basis of a fluid velocity, the pressure, a volume-of-fluid value and a velocity of the fluid around the solid at the time t; and second fluid simulation means for calculating a pressure of the fluid at the time t+Δt on the basis of the velocity and the volume-of-fluid value of the fluid at the time t+Δt and the velocity of the fluid around the solid at the time t+Δt set by the velocity setting means.

Further, the invention further provides a computer system for simulating movements of a fluid and a solid object both interacting with each other, including: a processor; a computer system memory accessible to the processing unit; and a program stored on the computer system memory. The program includes a converting section configured to convert a shape data value of the solid object into a volume-of-solid value; a mapping section configured to map the volume-of-solid value on a simulation mesh; a fluid external force calculating section configured to calculate an acting force on the solid object exerted by the fluid, by using the volume-of-solid value mapped on the simulation mesh; and an object simulation unit configured to simulate the movement of the solid object while taking into account the acting force on the solid object exerted by the fluid.

### BRIEF DESCRIPTION OF THE DRAWINGS

The present invention may be more readily described with reference to the accompanying drawings: in which

FIG. 1 is a schematic block diagram showing a configuration of an image processing system according to one embodiment of the present invention;

FIG. 2 is a schematic block diagram showing a configuration of a fluid and solid cooperative simulation apparatus according to the embodiment;

FIG. 3 is a flowchart showing the detailed procedure of the fluid and solid cooperative simulation according to the embodiment;

FIG. 4 is a diagram showing an example of local simulation meshes that enclose the area surrounding a solid;

FIG. 5 is a diagram for explaining a state of mapping, on the fluid simulation mesh, while taking into account the location and the posture of the solid;

FIG. 6 is a diagram showing the state of a force that acts on the solid; and

FIGS. 7A and 7B are diagrams showing example images that are output by the image processing system according to the embodiment.

FIG. 8 is a diagram showing a computer system according to another embodiment of the invention.

### DETAILED DESCRIPTION OF THE PREFERRED EMBODIMENTS

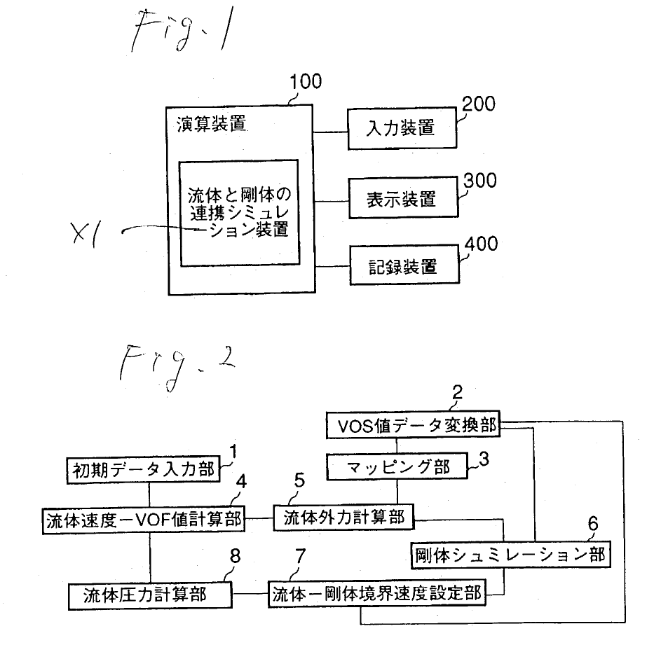

FIG. 1 is a schematic block diagram showing the configuration of an image processing system according to one embodiment of the present invention. This embodiment can be achieved by using a common computer, such as a personal computer (PC) or an engineering workstation. As shown in FIG. 1, for example, the embodiment broadly includes: a calculation processing unit 100, an input device 200, a display device 300 and a recording device 400. The calculation processing unit 100 includes a basic computer hardware configuration, such as a CPU, a memory and a system bus (not shown). An example fluid and solid cooperative simulation according to this invention is provided as a computer program. This program is read from the recording device 400, is stored in the memory, and is executed by the CPU. Instead of the computer program, a hardware circuit can be provided to perform the fluid and solid cooperative simulation according to this invention.

The input device 200 is a keyboard or a pointing device. A user can employ this input device 200 to enter various data required for a simulation, or to give the calculation processing unit 100 a command for starting execution of a simulation process. The display device 300 is a CRT, a liquid crystal display device or the like, which displays images for scenes generated as the simulation result of the calculation processing unit 100. Such images are called a computer graphics (CG) image. The recording device 400 is a hard disk, a magneto-optical disk (MO) or the like. The recording device 400 records execution data of a program relating to the fluid and solid cooperative simulation, initial data and shape data used for this simulation, or image data obtained by the simulation. In addition, a peripheral device, such as a printer, may be connected to the image processing system according to this embodiment.

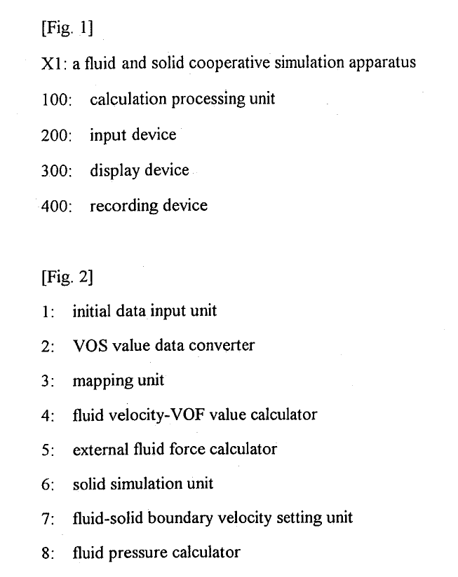

FIG. 2 is a schematic block diagram showing the configuration of a fluid and solid cooperative simulation apparatus according to this embodiment. As shown in FIG. 2, the cooperative simulation apparatus includes: an initial data input unit 1, a VOS (volume-of-solid) value data converter 2, a mapping unit 3, a fluid velocity-VOF (volume-of-fluid) value calculator 4, an external fluid force calculator 5, a solid simulation unit 6, a fluid-solid boundary velocity setting unit 7 and a fluid pressure calculator 8.

The initial data input unit 1 is used to enter initial data necessary for performing the fluid and solid cooperative simulation. The initial data are provided directly by a user through the input device 200, or are obtained from a data file recorded on the recording device 400. The initial data relating to an object of a simulation can be generally classified into fluid-related data and solid-related data.

The fluid-related data indicates analysis characteristic of the fluid in a mesh (hereinafter referred to as a (fluid) simulation mesh) The mesh is a stationary orthogonal mesh, which uniformly divides a virtual three-dimensional simulation space into minute cells. The fluid-related data include a velocity, a pressure and a VOF (volume-of-fluid) value of a fluid, and a velocity of the fluid surrounding the solid (fluid-solid boundary velocity). The initial data are provided for the velocity, the pressure and the, VOF value of the fluid.

The solid-related data includes shape data of the solid. In this case, the shape data are provided as an approximate representation of the three-dimensional shape of the solid using a combination of multiple polygons. The shape data include coordinate data for polygon vertexes-and vector data. The shape data can be created by using a well-known software such as a three-dimensional modeling tool.

Further, the VOS (volume-of-solid) value is used so that an analysis characteristic of the solid can be dealt with in the same dimension as that of the VOF value of the fluid. The VOS value is obtained by approximating the solid on a simulation mesh equivalent to the simulation mesh for the fluid in size. In the simulation mesh, the fluid and the solid are respectively expressed by the VOF and the VOS values. Thus, the interaction between the fluid and the solid can be appropriately calculated without any deterioration of the match represented by the two. In addition, simulation of a collision of the solid is performed using polygon data having a resolution higher than the VOS value.

Examples of other data related to the solid includes the location, the posture (rotation), the velocity and the angular velocity of the solid, the translational force and the torque, which are external forces exerted by the fluid on the solid, and an external force other than that exerted by the fluid. The initial data are provided for the location, the posture, the velocity and the angular velocity of the solid.

The shape data of the solid is entered using the initial data input unit 1 and converted into a VOS value by the VOS value data converter 2. The mapping unit 3 maps the VOS value obtained by the VOS value data converter 2 on the simulation mesh, taking the location and posture of the solid into account.

The respective movement of the fluid and of the solid while they interact with each other is simulated on the basis of the following calculation process for obtaining the state when a minute period of time At has elapsed since time t.

First, the fluid velocity-VOF value calculator 4 employs the velocity, the pressure, the VOF value and the solid boundary velocity of the fluid at time t to calculate the velocity and the VOF value of the fluid at time t+Δt, following the elapse of the minute period Δt.

On the other hand, based on the pressure of the fluid at time t, the external fluid force calculator 5 calculates the translational force and the torque as external forces, which are exerted by the fluid on the solid at time t. Then, the solid simulation unit 6 calculates the location, the posture, the velocity and the angular velocity of the solid at time t+Δt, following the elapse of the minute period Δt, while taking into account a collision with another solid, on the basis of thus obtained translational force and torque of the solid, an external force other than the external force exerted by the fluid on the solid at time t, and the location, the posture, the velocity and the angular velocity of the solid at time t.

At this time, based on the location, the posture, the velocity and the angular velocity of the solid at time t+Δt, which are obtained by the solid simulation unit 6, the mapping unit 3 again maps the VOS value of the solid on the fluid simulation mesh (updating of mapping). The fluid-solid boundary velocity setting unit 7 refers to the velocity of the solid at time t+Δt on the fluid simulation mesh in which the mapping of the VOS value has been updated, and then sets the solid boundary velocity of the fluid at time t+Δt at the same value as the referred velocity of the solid.

The fluid pressure calculator 8 calculates the pressure of the fluid at time t+Δt, on the basis of the velocity, the VOF value and the solid boundary speed of the fluid at time t+Δt.

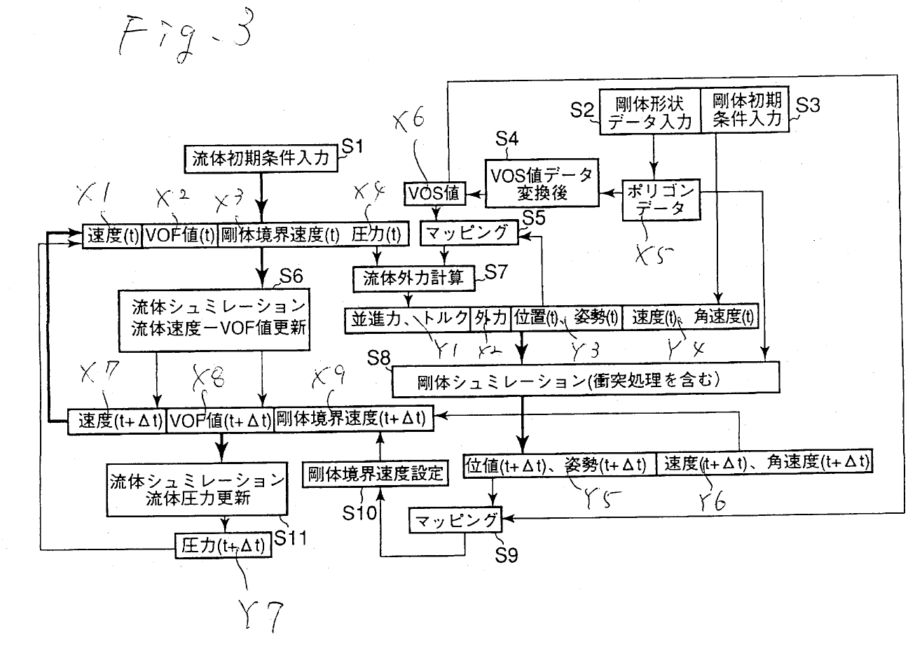

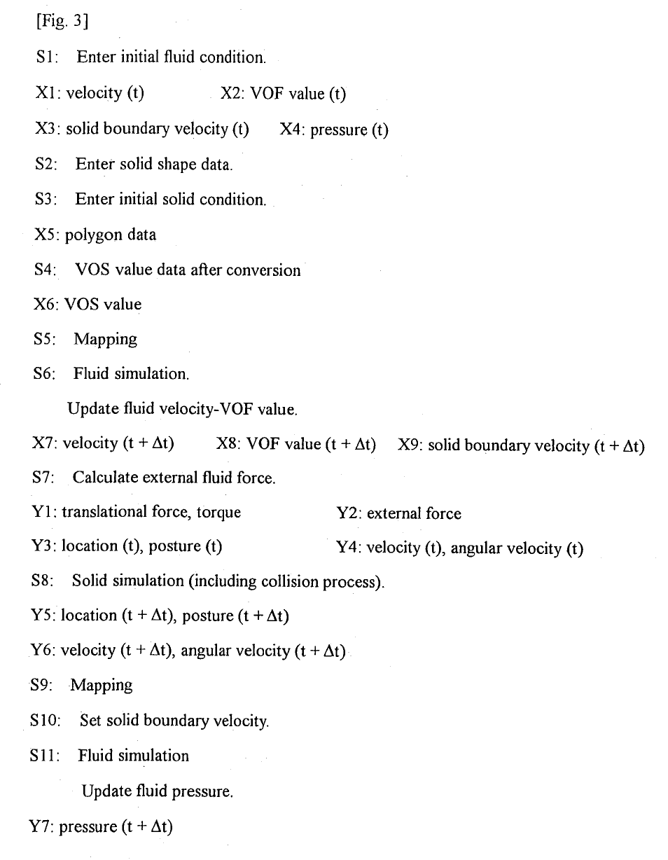

Detailed procedures for performing the fluid and solid cooperative simulation according to the embodiment will be explained as below, referring to the flowchart in FIG. 3.

The initial data for the velocity, the pressure and the VOF value of the fluid are entered into the initial data input unit 1 as an initial condition (step S1). Polygon data (shape data) for the solid and initial data for the location, the posture, the velocity and the angular velocity of the solid are also entered into the initial data input unit 1 (steps S2 and S3) Next, the VOS value data converter 2 converts the polygon data for the solid into the VOS value (step S4). FIG. 4 shows a locally arranged mesh that includes the whole and surrounding region of the solid. As described above, one cell in the mesh shown in FIG. 4 is equivalent in size to a cell in the simulation mesh for the fluid. The VOS value converter 2 calculates ratio of the volume of the solid portion occupying in the respective cell to the volume of the cell to obtain the VOS value. The thus obtained VOS value is set at a center grid of each cell. The VOS value may be calculated by interpolation, using a high-order function, such as a cubic function, of the VOS values of another grids, in the case where no VOS value is present in the cell.

The VOS value obtained by the VOS value data converter 2 is mapped by the mapping unit 3 in the simulation mesh (grids of the fluid (step S5). At this time, the mapping unit 3 takes into account the current location and the current posture of the solid, as is shown in FIG. 5. It should be noted that the hatched portions in the simulation mesh in FIG. 5 correspond to the VOS values.

Within the fluid simulation mesh in which the VOS value has been mapped at step S5, the fluid velocity at the boundary between the fluid and the solid is set on the basis of the initial values of the velocity and the angular velocity of the solid. In this specification, the velocity of the fluid is called a “solid boundary velocity”. When the time t is not the initial time (t≠0), the solid boundary velocity is calculated and set at step S10, which will be described later.

Next, based on the velocity, the pressure, the VOF value and the solid boundary velocity of the fluid at time t (time t=0 if it is the initial time), the fluid velocity-VOF value calculator 4 calculates the velocity and the VOF value of the fluid at time t+Δt, which follows time t after the minute period At has elapsed (step S6). For this process, the fluid velocity-VOF value calculator 4 employs the VOF method (Variable-Density Model) and the CIP method, which are publicly known. In addition, an example of the VOF method is described in detail in the document of “Volume Of Fluid (VOF) Method for the Dynamics of Free Boundaries,” C. W. Hirt and B. D. Nichols, Journal of Computational Physics, 39. pp. 201-225, (1981). An example of the CIP method is described in detail in the document of “Unified Solver CIP for Solid, Liquid and Gas”, T. Yabe, Computational Fluid Dynamics Review (1997).

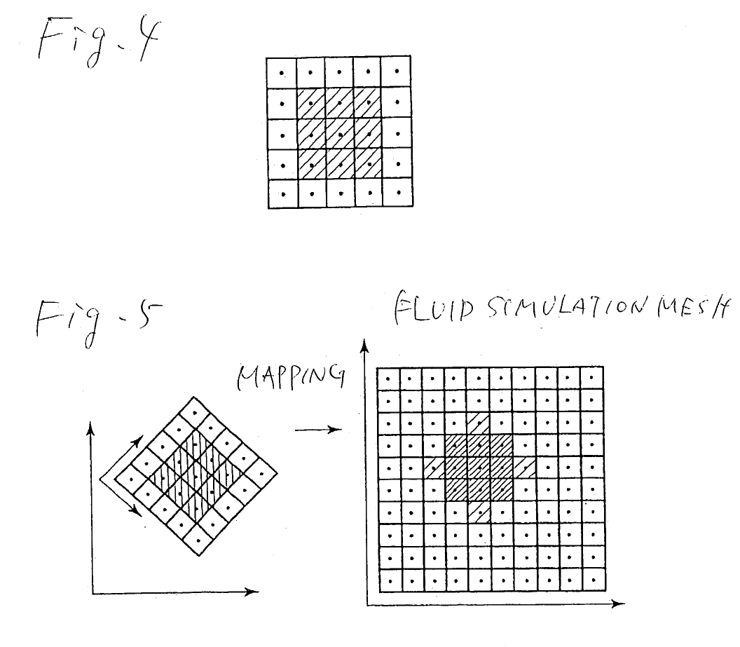

Sequentially, the pressure exerted by the fluid upon the entire solid at time t is calculated by referring to the simulation mesh on which the VOS value is mapped. For this calculation, while taking into account the location and the posture of the solid at time t and the solid boundary velocity, the pressure at time t is regarded as the total sum of the pressure vectors of the fluid at the boundary between the solid and the fluid. Based on the obtained pressure, the external fluid force calculator 5 calculates the translational force and the torque as external forces exerted by the fluid on the solid at time t (step S7). FIG. 6 is a diagram showing the state of the acting forces on the solid. In FIG. 6, an arrow np indicates the pressure applied by the fluid. An arrow Fc indicates the translational force. An arrow TC indicates a torque. It should be noted that external forces, such as atmospheric pressure, other than the force exerted by the fluid are also shown in FIG. 6.

Then, based on the location, the posture, the velocity, the angular velocity, the translational force and the torque of the solid at time t, and the external forces other than the force exerted by the fluid, the solid simulation unit 6 calculates the location, the posture, the velocity and the angular velocity of the solid at time t+Δt, after the elapse of a minute period following time t (step S8). Since this calculation is only for the solid, polygon data high in resolution are used instead of the VOS value. An example solid simulation calculation is described in detail in the document of “Physically based modeling: principles and practice”, D. Baraff and A. Witkin, SIGGRAPH 1997 Course Note (1997).

Within the solid simulation, it is preferable to simultaneously use a collision determination processing for determining whether a collision has occurred between solids during a period extending from time t to time t+Δt. If a collision is judged to occur between solids, a reactive force is calculated and exerted so that the solids are not embedded in each other. In addition, a closest feature algorithm can be employed for the determination of a collision between solids. An example for this method is described in reference document of “A fast algorithm for incremental distance calculation”, M. C. Lin and J. Canny, international Conference on Robotics and Automation, pp. 1008-1014 (1991). Further, an impulse-based method can be employed for the calculation of reaction forces for solids. An example of this method is described in reference document of “Impulse-base Dynamic Simulation of Rigid Body Systems”, Ph.D. thesis, University of California, Berkeley (1996).

Next, based on the location and the posture of the solid at time t+Δt, obtained at step S8, the mapping unit 3 maps, again in the fluid simulation mesh, the VOS value that represents the shape of the solid (step S9). That is, state of the solid after elapse of the minute time is reflected in the fluid simulation mesh. Based on the VOS value in the updated fluid simulation mesh, the fluid-solid boundary velocity setting unit 7 sets the velocity of the fluid (solid boundary velocity) at the boundary between the fluid and the solid (step S10). That is, the fluid-solid boundary velocity setting unit 7 refers the velocity of the solid at time t+Δt in the fluid simulation mesh where the mapping of the VOS value is updated, and sets the same value as is assigned for this velocity to the solid boundary velocity for the fluid at time t+Δt.

Based on the velocity, the VOF value and the solid boundary velocity of the fluid at time t+Δt, the fluid pressure calculator 8 calculates the pressure of the fluid at time t+Δt by using the VOF method and the CIP method (step S11).

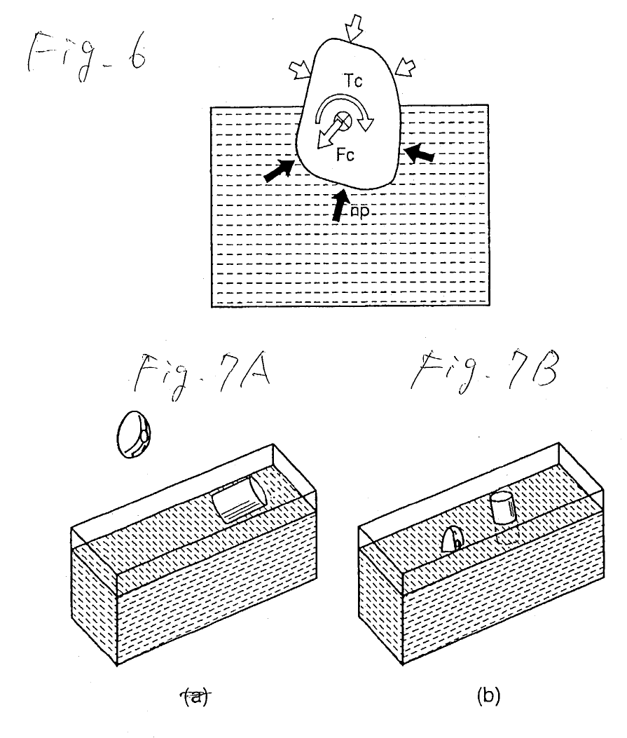

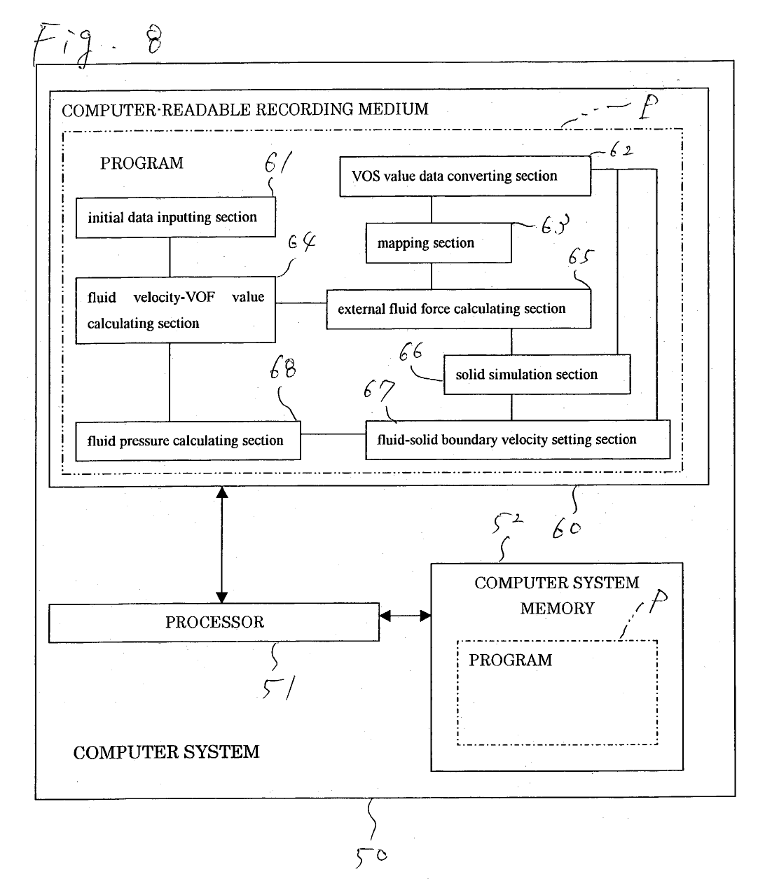

Through these calculations, the states of the fluid and the solid at time t+Δt, following the elapse of the minute period of time, can be obtained. This calculation is repeated while updating the time t until the time t reaches a desired time. When the time t reaches the desired time, the final image to be displayed is generated by a publicly known rendering process to be output to the display device 300. As a result, a scene for the desired time can be obtained. If the scenes on respective times are regarded as moving picture frames and are displayed at a predetermined frame rate, a CG animation can be created. An example image displayed on the display device 300 is shown in FIGS. 7A and 7B.

Conventionally, since scenes are created through repetitive trial and error in the CG field, it has been conceived difficult to create a scene in which a solid exists in a complicatedly moving fluid. However, the embodiment of the invention can resolve this problem. Specifically, first, the movement of the fluid is calculated by using the VOS value that is provided as the approximate shape data for the solid based on the fluid simulation mesh, and computational efforts for calculations are not increased. Further, although for accuracy it is slightly disadvantageous, setting the velocity of the solid obtained by the solid simulation as the velocity of the surrounding fluid (solid boundary velocity) can greatly contribute to a reduction in computational efforts.

Further, the movement of the solid in the fluid is simulated using polygon data. And therefore, a scene can be generated realistic and natural in visual appearance.

Incidentally, in the embodiment, another configuration may be adopted without departing from the scope and spirit of the invention. For example, the program for attaining the functions in the embodiment may be recorded in a computer-readable recording medium. In this case, as shown in FIG. 8, a program P for attaining the functions in the embodiment is recorded in a computer-readable recording medium 60 that can be installed in a computer system 50. The program P includes: an initial data inputting section 61, a VOS (volume-of-solid) value data converting section 62, a mapping section 63, a fluid velocity-VOF (volume-of-fluid) value calculating section 64, an external fluid force calculating section 65, a solid simulation section 66, a fluid-solid boundary velocity setting section 67 and a fluid pressure calculating section 68, each can perform the same function as the respective units 1-7 shown in FIG.2. The computer system 50 includes a processing unit 51 and a computer system memory 52 accessible to the processing unit 51. The program P is read by the processor 51 and expanded in the computer system memory 52 to be executed by the processor 51.

Incidentally, the “computer system” mentioned here may include an operation system or hardware such as peripheral equipment.

In addition, the “computer system” may include a homepage providing environment (or display environment) when it uses a WWW system.

On the other hand, the “computer-readable recording medium” means a portable medium such as a flexible disk, a magneto-optical disk, a ROM or a CD-ROM, or a storage unit such as a hard disk included in the computer system. Further the “computer-readable recording medium” may include a medium for holding the program for a predetermined time, such as a volatile memory (RAM) in a computer system as a server or a client when the program is transmitted through a network such as the Internet or a communication circuit such as a telephone circuit.

In addition, the program may be transmitted from a computer system storing the program in a storage unit or the like to another computer system through a transmission medium or by a transmitted wave in the transmission medium. Here, the “transmission medium” for transmitting the program means a medium having a function of transmitting information, including a network (communication circuit) such as the Internet or a communication circuit (communication line) such as a phone line.

In addition, the program may be prepared for attaining a part of the aforementioned functions. Further, the program may be a so-called difference file (difference program) which can attain the aforementioned functions in combination with a program which has been already recorded in the computer system.

Further, these modifications may be used selectively and suitably in combination.

What is claimed is:

1. A simulation apparatus for simulating movements of a fluid and a solid both interacting with each other, comprising:
a mesh setting unit configured to set a uniform simulation mesh in an object region of a simulation;
a solid shape setting unit configured to set a shape of the solid in the uniform simulation mesh; and
a solid simulation unit configured to simulate the movement of the solid on the basis of the shape while taking into account an acting force on the solid exerted by the fluid.

2. The simulation apparatus according to claim 1, wherein the solid shape setting unit sets the shape of the solid in the uniform simulation mesh by using a predetermined parameter.

3. The simulation apparatus according to claim 2, wherein the predetermined parameter is a volume-of-solid value.

4. The simulation apparatus according to claim 1, wherein the uniform simulation mesh is an orthogonal mesh.

5. A simulation apparatus for simulating movements of a fluid and a solid object both interacting with each other, comprising:
an object shape setting unit configured to set a shape of the solid object in a simulation mesh;
a fluid external force calculating unit configured to calculate an acting force on the solid object exerted by the fluid; and
a object simulation unit configured to simulate the movement of the solid object while taking into account the acting force on the solid object exerted by the fluid.

6. The simulation apparatus according to claim 5, further comprising:
wherein
the object shape setting unit includes a converting unit configured to convert a shape data value of the solid object into a volume-of-solid value and a mapping unit configured to map the volume-of-solid value on the simulation mesh; and
the fluid external force calculating unit calculates the acting force using the volume-of-solid value mapped on the simulation mesh.

7. The simulation apparatus according to claim 6, wherein the mapping unit updates mapping of the volume-of-solid value on the simulation mesh on the basis of location and posture of the solid object calculated by the object simulation unit.

8. The simulation apparatus according to claim 5, further comprising:
a velocity setting unit configured to set a velocity of the fluid around the solid object depending on the movement of the solid object simulated by the object simulation unit; and
a fluid simulation unit configured to simulate movement of the fluid while taking into account the velocity set by the velocity setting unit.

9. The simulation apparatus according to claim 5, wherein
the solid object includes a plurality of solid objects; and
the object simulation unit use a collision determination processing for determining whether a collision occurs between the plurality of solid objects.

10. A simulation apparatus for simulating movements of a fluid and a solid both interacting with each other, comprising:
a converting unit configured to convert a shape data value of the solid into a volume-of-solid value;
a mapping unit configured to map the VOS value on a simulation mesh;
an external force calculating unit configured to employ pressure of the fluid at a time t to calculate a translational force and a torque acting on the solid at the time t;
a solid simulation unit configured to calculate the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t;
a velocity setting unit configured to set fluid velocity around the solid at the same value as the velocity of the solid at the time t+Δt;
a first fluid simulation unit configured to calculate a fluid velocity and a volume-of-fluid value at the time t+Δt on the basis of a fluid velocity, the pressure, a volume-of-fluid value and a velocity of the fluid around the solid at the time t; and
a second fluid simulation unit configured to calculate a pressure of the fluid at the time t+Δt on the basis of the velocity and the volume-of-fluid value of the fluid at the time t+Δt and the velocity of the fluid around the solid at the time t+Δt set by the velocity setting unit.

11. The simulation apparatus according to claim 10, wherein the solid simulation unit uses polygon data as a shape data of the solid.

12. A simulation method for simulating movements of a fluid and a solid both interacting with each other, comprising:
setting a shape of the solid in a uniform simulation mesh; and
simulating the movement of the solid on the basis of the shape while taking into account an acting force on the solid exerted by the fluid.

13. The simulation method according to claim 12, further comprising: calculating the acting force on the solid;
wherein
the step of setting the solid shape includes converting a shape data value of the solid into a volume-of-solid value and mapping the volume-of-solid value on the uniform simulation mesh; and
the volume-of-solid value mapped on the uniform simulation mesh is used for calculating the acting force.

14. A simulation method for simulating movements of a fluid and a solid both interacting with each other, comprising:
converting a shape data value of the solid into a volume-of-solid value;
mapping the volume-of-solid value on a simulation mesh;
calculating a translational force and a torque acting on the solid at the time t by using pressure of the fluid at a time t;
calculating the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t;
setting fluid velocity around the solid at the same value as the velocity of the solid at the time t+Δt;
calculating a fluid velocity and a volume-of-fluid value at the time t+Δt on the basis of a fluid velocity, the pressure, a volume-of-fluid value and a velocity of the fluid around the solid at the time t; and
calculating a pressure of the fluid at the time t+Δt on the basis of the velocity and the volume-of-fluid value of the fluid at the time t+Δt and the velocity of the fluid around the solid at the time t+Δt.

15. A simulation program for computationally simulating movements of a fluid and a solid that interact with each other, the simulation program causes a computer to function as:
mesh setting means for setting a uniform simulation mesh in an object region of a simulation;
solid shape setting means for setting a shape of the solid in the uniform simulation mesh; and
solid simulation means for simulating the movement of the solid on the basis of the shape while taking into account an acting force on the solid exerted by the fluid.

16. A recording medium for recording a simulation program for computationally simulating movements of a fluid and a solid that interact with each other in a computer, the program causes the computer to function as:
converting means for converting a shape data value of the solid into a volume-of-solid value;
mapping means for mapping the VOS value on a simulation mesh;
external force calculating means for employing pressure of the fluid at a time t to calculate a translational force and a torque acting on the solid at the time t;
solid simulation means for calculating the location, the posture, the velocity and the angular velocity of the solid at a time t+Δt on the basis of the translational force, the torque and an external force other than the force exerted by the fluid that acts on the solid at the time t, and a location, a posture, a velocity and an angular velocity of the solid at the time t;
velocity setting means for setting fluid velocity around the solid at the same value as the velocity of the solid at the time t+Δt;
first fluid simulation means for calculating a fluid velocity and a volume-of-fluid value at the time t+Δt on the basis of a fluid velocity, the pressure, a volume-of-fluid value and a velocity of the fluid around the solid at the time t; and
second fluid simulation means for calculating a pressure of the fluid at the time t+Δt on the basis of the velocity and the volume-of-fluid value of the fluid at the time t+Δt and the velocity of the fluid around the solid at the time t+Δt set by the velocity setting means.

17. A computer system for simulating movements of a fluid and a solid object both interacting with each other, comprising:
a processor;
a computer system memory accessible to the processing unit; and
a program stored on the computer system memory;
wherein the program includes:
a converting section configured to convert a shape data value of the solid object into a volume-of-solid value;
a mapping section configured to map the volume-of-solid value on a simulation mesh;
a fluid external force calculating section configured to calculate an acting force on the solid object exerted by the fluid, by using the volume-of-solid value mapped on the simulation mesh; and
an object simulation unit configured to simulate the movement of the solid object while taking into account the acting force on the solid object exerted by the fluid.
